(19) United States
(12) Patent Application Publication
(10) Pub. No.: US 2007/0204704 A1
(43) Pub. Date: Sep. 6, 2007

(54) Sensor

(76) Inventor: Stephan Gneuss, Bad Oeynhausen (DE)

Correspondence Address: FRIEDRICH KUEFFNER, 317 MADISON AVENUE, SUITE 910, NEW YORK, NY, 10017, US

(21) Appl. No.: 10/575,329

(22) PCT Filed: Oct. 15, 2004
(86) PCT No.: PCT/EP04/11579

§ 371 Date: Jan. 16, 2007

(30) Foreign Application Priority Data
Oct. 17, 2003 (DE) 103 49 008.6

(51) Int. Cl. G01D 21/00

(52) U.S. Cl. 73/866.5

(57) ABSTRACT

The invention relates to a sensor (1) which is used to record measuring values in a melt (5). Said sensor can be inserted into a bore (2) of the wall (3) surrounding a cavity (4) which receives the melt (5), and is further developed so that it can be withdrawn from the wall (3) when the melt has substantially solidified without much effort and without damaging the sensor (1). The sensor is associated with at least one heating device (9).

The invention relates to a sensor that is used to record measuring values in a melt. The said sensor can be inserted into a bore of the wall surrounding a cavity that receives the melt.

Such sensors are known. They are used to measure, for example, the pressure of the melt in melt ducts, extruders, purification filters or the like. Such sensors are replaceable, for example, screwed via a thread into the bore of the wall. The tip of the sensors thereby regularly extends as far as the melt or into the melt.

In the event of a sensor defect or should the sensor need to be exchanged for another, the sensor can be screwed out of the wall. During operation the melt, which is regularly under pressure, would seep out after screwing the sensor out of the bore. A new sensor would be extremely difficult to insert. For this reason, such sensors are exchanged when the melt has solidified. Plastics, also technical plastics such as polycarbonate stick to the sensor in the process and penetrate the threads between the bore and the sensor. For this reason the sensor is stuck tightly, is stuck together with the wall, and can only be screwed out with much force. In order that the sensor tip is loosened from the solidified, sticky melt, and is not damaged, it has already been put forward to provide the tip, for example, the membrane for a pressure sensor, with a special coating. The clotted threads however still cause serious problems during the sensor exchange. Also, the coating cannot always prevent damage to the membrane.

It is the object of the invention to further develop sensors according to the invention so that these can be exchanged when the melt has substantially solidified without much effort and without damaging the sensor.

For this purpose, it is put forward that the sensor is associated with at least one heating device. The heating device causes the sensor and the surrounding areas to warm up to a temperature at which the solidified melt is liquefied in areas. On the one hand, this causes the melt located in the threads to liquefy, so that the sensor can be screwed out easily. On the other hand, this causes the tip, for example, the membrane of a pressure sensor, which is directly in contact with the melt to be heated such that the solidified melt surrounding the tip of the sensor is melted, so that the tip can also be turned out of the otherwise solidified melt without being damaged.

It is advantageous if the sensor exhibits a heating device. In this way the sensor and the immediately surrounding areas can be heated with a relatively low heating output. Larger areas of the walls and of the melt do not have to be heated.

It is advantageous in this regard that at least the part which extends into the melt as well as the sensor part which is surrounded by the bore can be heated. This makes it possible that the tip extending into the solidified melt and the threads which are clotted by the solidified melt can be specifically heated.

However, it has also proven advantageous that the heating device is provided in the area of the bore surrounding the sensor, preferably in a sleeve which receives the sensor and which is insertable into the bore. This sleeve can be used alone or also in connection with the heatable sensor described above. The sleeve safely ensures that the threads which are clotted by the solidified melt and located between the sleeve inserted into the bore and the sensor can reach temperatures at which the melt exhibits a sufficient viscosity to turn out the sensor.

It is an advantage if the heating devices are associated with at least one control unit for adjusting the heating output. This makes it possible to exactly adjust the temperature of the sensor and/or of the sleeve, even when treating different plastics having varying melting points.

The heating can function inductively or by means of tempered fluids or gases; however, it is preferably operated electrically. Electrical heating cartridges can be arranged in the sensor and/or in the sleeve particularly easily. The control unit can be operated in a way such that the sensor and the area surrounding it can be heated following the cooling of the system to a temperature which ensures a damage-free exchange of the sensor. There is however also the possibility that the control unit is used to maintain the sensor and the areas immediately surrounding the sensor at a temperature during the cooling of the melt.

The invention is described in more detail in the description of the drawing as follows:

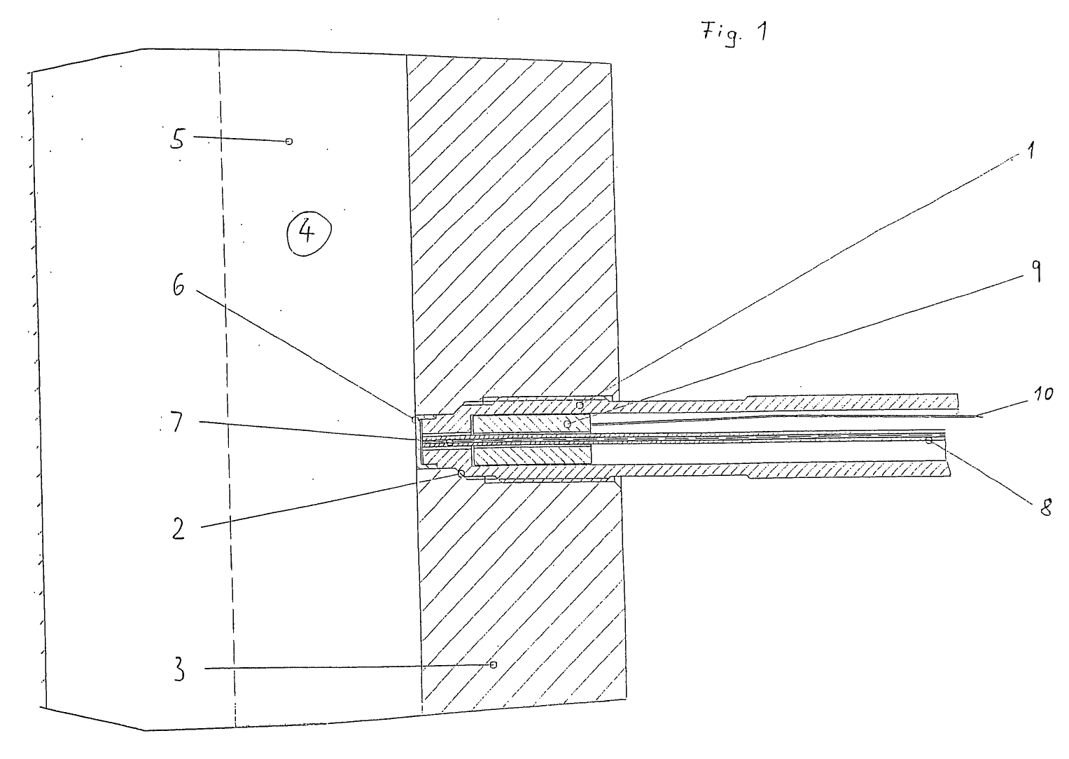

FIG. 1 shows a sensor according to the invention, and

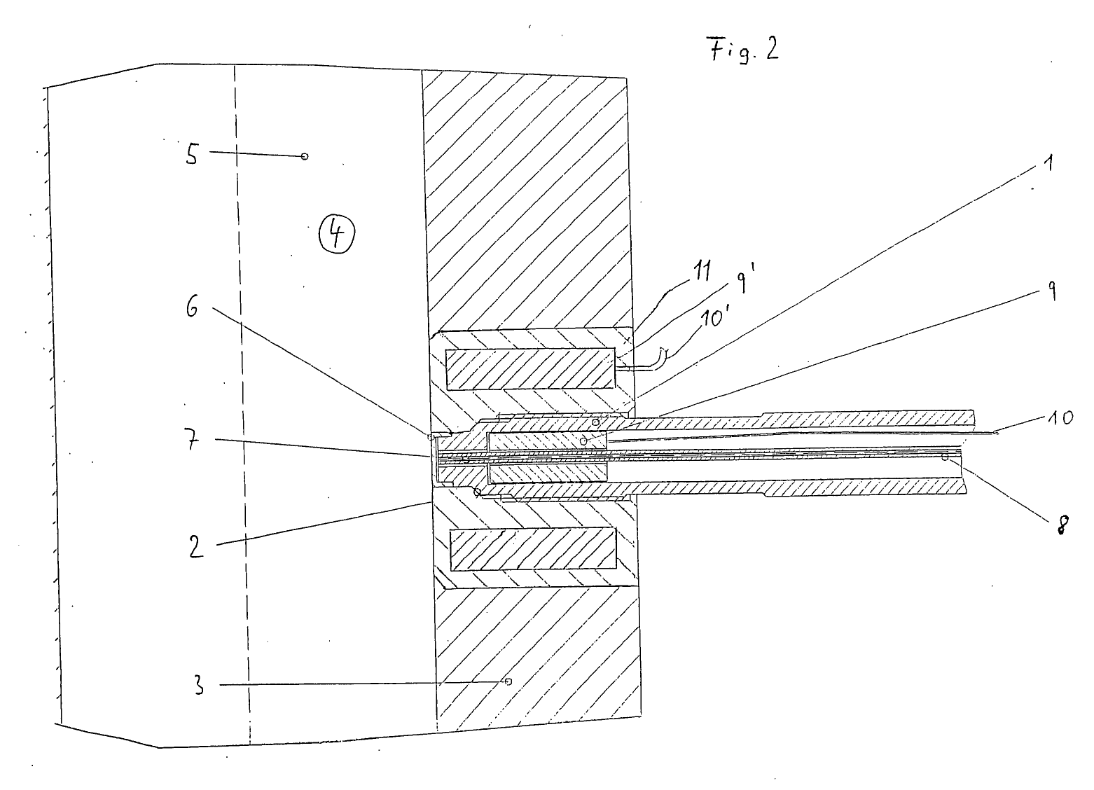

FIG. 2 shows a sensor according to Fig. with an additional heatable sleeve.

FIG. 1 shows a sensor 1 which is screwed into the bore 2 of a wall 3. The wall 3 corresponds to the boundaries of a cavity 4, for example of a melt duct, in which the melt 5 is contained. The sensor 1 is shown as a pressure sensor. Temperature sensors, sensors for determining the flow rate, etc. are similarly designed with respect to the heating device.

The pressure sensor 1 exhibits a pressure membrane 6 which works on a transfer medium 7 for transmitting the pressure values, for example mercury, which is guided to a pressure transformer, not shown, via a capillary 8.

A heating device 9, for example an electrical heating cartridge, which is powered with the necessary energy via an electrical connection 10 is inserted into the sensor 1. The heating cartridge can be replaced, for example by a heating, which works by means of tempered fluids or gases or even by means of inductive heating.

When the melt 5 is solidified, the heater 9 may be brought to a temperature via a control unit, not shown herein, such that the melt 5 is plasticized in the immediate vicinity of the pressure membrane 6. In addition, this makes it possible that the solidified melt pressed into the threads between the wall 3 and the sensor 1 is also influenced with respect to its viscosity, so that the sensor can be screwed out of the bore 2 without much effort.

In this way, it is possible that neither the membrane is damaged nor the sensor destroyed by using major force.

FIG. 2 shows that a sleeve 11 is inserted into the wall 3. The sleeve 11 can be heated via a heating device 9′. FIG. 2 shows a sensor 1 as it has already been described in FIG. 1. However, there is also the possibility to use a sensor which does not exhibit a heating device 9.

### LIST OF REFERENCE NUMBERS

1 Sensor
2 Bore
3 Wall
4 Cavity
5 Melt
6 Pressure membrane
7 Transfer medium
8 Capillary
9 Heating device
10 Electrical connection
11 Sleeve

1. A sensor for recording measuring values in a melt, said sensor can be inserted into a bore of the wall surrounding the cavity which receives the melt, wherein the sensor is associated with at least one heating device.

2. The sensor according to claim 1, wherein the sensor exhibits a heating device.

3. The sensor according to claim 2, wherein at least the part of the sensor which extends into the melt as well as the part of the sensor which is surrounded by the bore can be heated.

4. The sensor according to claim 1, wherein the heating device is designed to be in the area of the bore surrounding the sensor, preferably in a sleeve which receives the sensor and which can be inserted into the bore.

5. The sensor according to claim 1, wherein at least one control unit is associated with the heating devices for adjusting the heat output.

6. The sensor according to claim 1, wherein the heating devices can be heated electrically, inductively or by means of fluids or gases which can be tempered.

7. The sensor according to claim 5, wherein the sensor can be heated via a control unit for the purpose of being exchanged when the melt is solidified.

8. The sensor according to claim 5, wherein the sensor can be kept at a temperature for the purpose of being exchanged when the melt is solidified.
